(19) United States
(12) Patent Application Publication
(10) Pub. No.: US 2003/0085538 A1
(43) Pub. Date: May 8, 2003

(54) Shopping cart with locking compartment

(76) Inventor: Silvia Mansons, Fort Lauderdale, FL (US)

Correspondence Address: Mark D. Bowen, Stearns Weaver Miller, et al., Suite 1900, 200 East Broward Boulevard, Fort Lauderdale, FL, 33301, US

(21) Appl. No.: 10/270,043

(22) Filed: Oct. 11, 2002

Related U.S. Application Data
(60) Provisional application No. 60/328,675, filed on Oct. 11, 2001.

(51) Int. Cl. B62B 3/00

(52) U.S. Cl. 280/33.992

(57) ABSTRACT

A security enclosure for use with a retail shopping cart includes a hingedly connected assembly that is manually deployable from a stowed configuration wherein the enclosure is generally collapsed adjacent to an inner front portion of the main basket wall, to a deployed configuration wherein a secure enclosure is formed with a lockable top cover. In the stowed configuration, the security enclosure a compactly collapsed adjacent to the inner front wall of the shopping cart so as not to substantially reduce the article carrying volume of the cart, or otherwise interfere with the ability of the cart to be nested with other carts during storage. In the deployed configuration, the security enclosure defines a secure compartment bounded on all sides with a latching and/or locking cover.

### CROSS REFERENCE TO RELATED APPLICATIONS

This application claims the benefit of U.S. Provisional Patent Application Serial No. 60/328,675, filed Oct. 11, 2001.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

This invention relates to shopping carts, and, more particularly, to shopping carts adapted with a deployable enclosure for secure, temporary storage of purses and other personal articles so as to deter theft.

2. Description of the Background Art

It is common for shoppers to utilize shopping carts for holding and transporting products while shopping in a retail environment. Typical shopping carts are characterized as manually propelled (e.g. by pushing) wheeled vehicles having a basket type frame. Shopping carts are commonly used in retail shopping environments for carrying goods. While shopping, people often place personal items in their shopping cart. Typical shopping carts, however, do not provide for the secure storage of valuable articles, such as a shopper's purse, wallet, personal electronic devices, etc. Unfortunately, people often leave personal articles, or valuable items purchased from another store, in open shopping carts in crowded shopping environments. As a result, many shoppers have been victimized by acts of petty theft when valuables are stolen from unattended shopping carts, or pilfered while a shopper's attention is drawn away from the cart.

In response to these problems in the art, others have proposed adapting shopping carts to provide for more secure temporary storage. The following patents provide examples of these proposals.

| | |
|---|---|
| 4,361,340 | Soriano |
| 4,583,753 | Economy |
| 4,643,280 | Hensley |
| 5,002,292 | Myers |
| 5,542,697 | Harris |
| 5,915,631 | Laxton et. al. |
| 6,056,178 | Rapp-Duncan |

U.S. Pat. No. 4,361,340, issued to Soriano, discloses modification of a grocery cart to provide an enclosed compartment for the temporary containment of valuables. The compartment is formed toward the rear of the cart near the handle assembly and under the child seat structure. U.S. Pat. No. 4,643,280, issued to Hensley, discloses a box-like article-carrying structure for use with shopping carts. The Hensley device is specifically designed to occupy a deployed child seat of a shopping cart. U.S. Pat. No. 5,002,292, issued to Myers, discloses a box-like security compartment for shopping carts that is mounted within the main basket toward the front portion of the cart. U.S. Pat. No. 5,542,687, issued to Harris, discloses a shopping cart having a security enclosure located at the rear of the cart beneath the deployed child seat. U.S. Pat. No. 6,056,178, issued to Rapp-Duncan, discloses an auxiliary bin having a very small open grid work for attachment to the front end of a shopping cart.

While the devices disclosed in the background art appear adequate for the basic purposes for which they have been specifically designed, they fail to provide a simple security apparatus for shopping carts that is deployable from a stowed configuration to provide a secure enclosure disposed toward the upper front edge of the cart for temporary storage of personal items while shopping. As a result of the shortcomings of the background art, there has exists a need for a new and improved deployable secure storage compartment for shopping carts.

### BRIEF SUMMARY OF THE INVENTION

The present invention provides a deployable secure enclosure for attachment to a shopping cart to allow shoppers to store valuables while shopping. The security enclosure comprises a hingedly connected assembly that is manually deployable from a stowed configuration wherein the enclosure is generally collapsed adjacent to an inner front portion of the main basket wall, to a deployed configuration wherein a secure enclosure is formed with a lockable top cover. In the stowed configuration, the security enclosure a compactly collapsed adjacent to the inner front wall of the shopping cart so as not to substantially reduce the article carrying volume of the cart, or otherwise interfere with the ability of the cart to be nested with other carts during storage.

In a preferred embodiment, the deployable security enclosure comprises a main panel pivotally connected along a bottom portion of the shopping cart, at or near the front main basket wall so as to be pivotally movable between stowed and deployed configurations. In the stowed configuration, the main panel is generally vertically disposed, parallel with and adjacent to the inner front portion of the cart. In the deployed configuration the main panel is generally angularly disposed such that the top edge thereof is inwardly spaced from the top front edge of the cart thereby defining an enclosed volume having a generally triangular cross-section. A floor panel is connected proximate the mid portion of the main panel by a hinged connection so as to be pivotally movable during deployment between a generally vertical position—when in the stowed configuration, to a generally horizontal position between the main panel and the front of the cart. A panel is connected proximate the upper edge of the main panel by a hinged connection so as to be pivotally movable between a generally vertical position—when in the stowed configuration, to a generally horizontal closed position in the deployed configuration—wherein a secure enclosure is formed. As should be apparent the enclosure is bounded by the floor panel, the existing cart front and opposing sidewalls, the deployed main panel, and the lockable cover. In a preferred embodiment, a simple latch may be used to lock the cover.

Accordingly, it is an object of the present invention to provide a security enclosure for shopping carts.

Yet another object of the present invention is to provide a security enclosure for shopping carts that is deployable from a stowed configuration at the front of the cart.

Still another object of the present invention is to provide a security enclosure that does not substantially reduce the carrying capacity of a shopping cart when in a stowed configuration.

Still further objects and advantages will become apparent from a consideration of the ensuing description and drawings.

### BRIEF DESCRIPTION OF THE SEVERAL VIEWS OF THE DRAWINGS

FIG. 1 is a side view of a shopping cart adapted with a security enclosure according to the present invention in the deployed configuration;

FIG. 2A is a side view of a security enclosure assembly in the deployed configuration;

FIG. 2B is a side view of a security enclosure assembly in the stowed configuration;

FIG. 3 is a side view of a shopping cart with a security enclosure assembly in the stowed configuration;

FIG. 4 is a front view of a shopping cart with the security enclosure in the deployed configuration with the top down;

FIG. 5 is a front view of the security enclosure prior to installation in a shopping cart; and

FIG. 6 is a perspective view of the security enclosure prior to installation in a shopping cart.

### DETAILED DESCRIPTION OF THE INVENTION

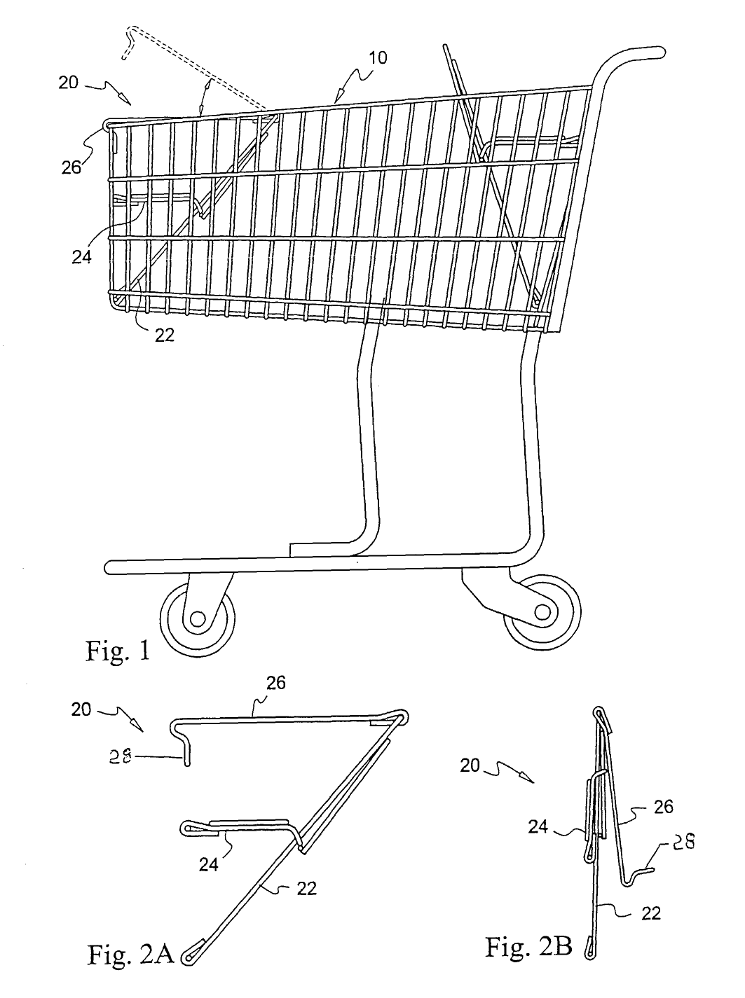

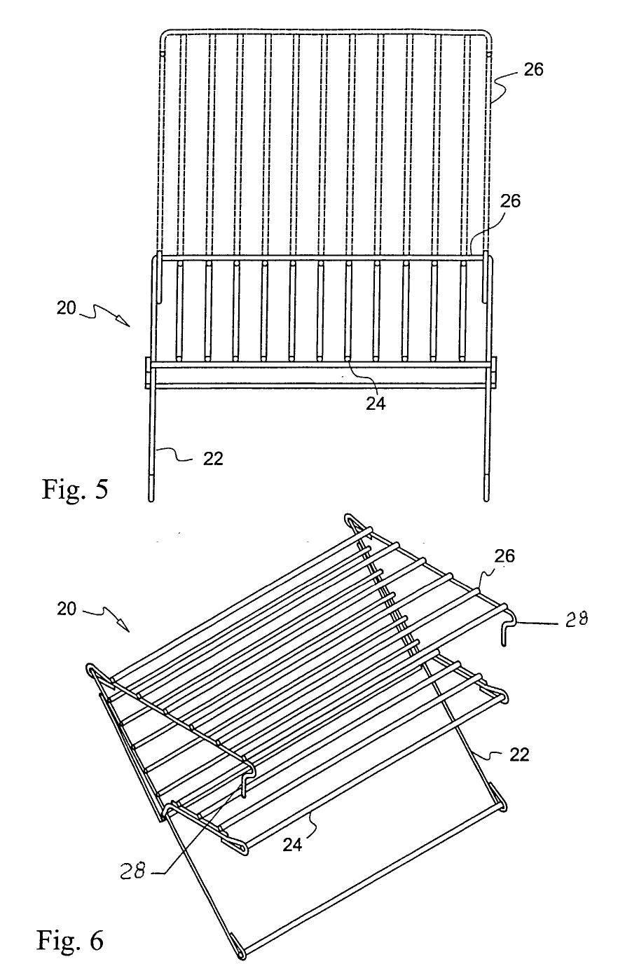

With reference now to the drawings, FIGS. 1-6 depict a preferred embodiment of a deployable security enclosure for a shopping cart. FIG. 1 depicts a shopping cart, referenced as 10, adapted with a secure enclosure according to the present invention, generally referenced as 20. The typical shopping cart has a tubular metal frame defining an open topped shopping basket supported on a pair of spaced-apart rear wheels and journalized front wheels. The basket is defined by integrally connected front and rear walls and opposing side walls connected around the periphery of the basket floor. Such carts typically include a handle extending rearward from the frame to allow a shopper to push the cart.

The present invention provides a deployable security enclosure for attachment to a shopping cart to allow shoppers to store valuables while shopping. Security enclosure 20 comprises a hingedly connected assembly that is manually deployable from a stowed configuration wherein the enclosure is generally collapsed adjacent to the inner front main basket wall as shown in FIG. 3, to a deployed configuration wherein a secure enclosure is formed with a lockable top cover, as shown in FIG. 1. As best seen in FIG. 1, in the deployed configuration, security enclosure 20 is pivotally deployed so as to define a cage structure defining an interior volume. As best seen in FIG. 3, in the stowed configuration, security enclosure 20 a compactly collapsed adjacent to the inner front wall of the shopping cart so as not to substantially reduce the article carrying volume of the cart or otherwise interfere with the ability of the cart to be nested with other carts as is common. While the embodiment depicted in FIG. 3 shows a portion of the enclosure projecting above the open top of the shopping cart, other embodiments wherein the enclosure does not so project in the stowed configuration are considered within the scope of the present invention.

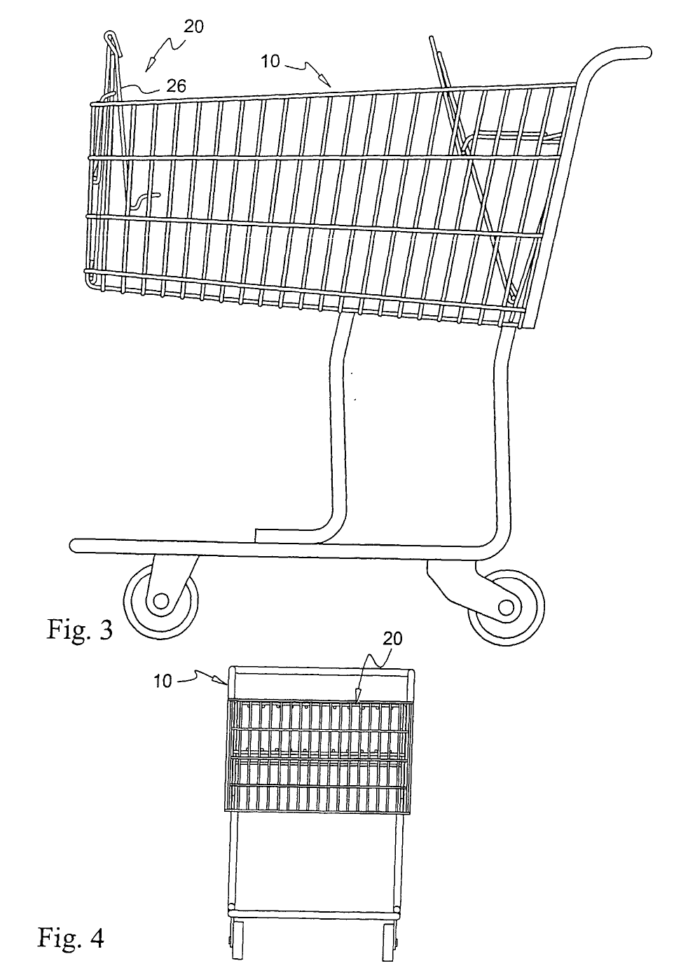

In a preferred embodiment, the deployable security enclosure comprises a main panel 22 pivotally connected along a bottom portion thereof to the shopping cart at or near the main basket front wall so as to be pivotally movable between stowed and deployed configurations. In the stowed configuration seen in FIGS. 2B and 3, the main panel is generally vertically disposed, parallel with and adjacent to the inner front portion of the cart. In the deployed configuration, shown in FIGS. 1 and 2A, the main panel is generally angularly disposed such that the top edge thereof is spaced from the top front edge of the cart thereby defining an enclosed volume having a generally triangular cross-section. A floor panel member 24 is connected proximate the mid portion of the main panel by a hinged connection so as to be pivotally movable during deployment between a generally vertical position when in the stowed configuration to a generally horizontal position between the main panel and the front of the cart. A cover panel member 26 is connected proximate the upper edge of the main panel by a hinged connection so as to be pivotally movable between a generally vertical position when in the stowed configuration to a generally horizontal closed position wherein a secure enclosure is formed. As seen in FIGS. 4-6 the apparatus deploys within the shopping cart basket to define a secure enclosed volume for temporary storage of personal articles. As should be apparent from the accompanying drawings, the enclosure is bounded by floor panel 24, the cart's front and opposing side walls, the deployed main panel 22 and the lockable cover panel 26. Each panel includes a plurality of cross-bar members to prevent unwanted access to the enclosure, and particularly to unwanted access to articles contained therein. In a preferred embodiment, a simple latching mechanism 28 may be used to lock the cover. In an alternate embodiment, the apparatus may be adapted with a locking device (e.g. combination or key) for increased security.

A shopping cart adapted with the security enclosure of the present invention thus provides a deployable secure enclosure for temporary storage of personal articles, such as purses, wallets, cellular telephones, and articles previously purchased at other stores.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

1. In a shopping cart having an open topped basket defined by a bottom, opposing front and rear walls and opposing side walls, a deployable secure enclosure comprising:
a deployable secure locking enclosure assembly, said assembly being hingedly connected to said basket proximate said shopping cart front wall;
said assembly being manually deployable from a stowed configuration wherein said assembly is generally collapsed adjacent to said front basket wall, to a deployed configuration wherein a secure enclosure is formed;
said secure enclosure including a top cover, said top cover positionable between an open configuration and a closed configuration.

2. In a shopping cart according to claim 1, wherein said top cover includes means for latching said cover in the closed configuration.

3. In a shopping cart according to claim 2, wherein said means for latching includes means for locking said cover in the closed configuration.

4. In a shopping cart according to claim 1, wherein in the deployed configuration said secure enclosure is bounded by a portion of said basket front wall, portions of said basket opposing side walls, said top cover, and an enclosure floor, said enclosure floor being substantially horizontal and elevated relative to said basket bottom.

5. A deployable secure locking enclosure for use with a wheeled shopping cart of the type having an open topped basket defined by a bottom, opposing front and rear walls and opposing side walls, said deployable secure locking enclosure comprising:
a deployable secure locking enclosure assembly, said assembly being hingedly connected to said basket proximate said shopping cart front wall;
said assembly including: a main panel having a bottom portion thereof pivotally connected to the shopping cart in proximity to the cart front wall; a floor panel having a first side thereof pivotally connected to the cart front wall and a second side thereof in sliding engagement with said main panel; and a cover panel having a first side thereof pivotally connected to a top portion of said main panel;
said assembly being manually deployable from a stowed configuration wherein said assembly is generally collapsed adjacent to said front basket wall with each of said panel members in closely spaced parallel relation therewith, to a deployed configuration wherein a secure enclosure is formed;
said secure enclosure being bounded by a portion of said basket front wall, portions of said basket opposing side walls, said main panel, said cover panel, and said floor panel, wherein said floor panel is substantially horizontal and elevated relative to said basket bottom.

6. A deployable secure locking enclosure according to claim 5, wherein said cover panel includes means for latching said cover in a closed configuration.

7. A deployable secure locking enclosure according to claim 6, wherein said means for latching includes means for locking said cover panel in the closed configuration.
